(19) United States
(12) Patent Application Publication
(10) Pub. No.: US 2002/0017224 A1
(43) Pub. Date: Feb. 14, 2002

(54) Method for the treatment of pozzolanic materials

(76) Inventor: Robert Horton, Carefree, AZ (US)

Correspondence Address: MARSH FISCHMANN & BREYFOGLE LLP, Suite 411, 3151 S. Vaughn Way, Aurora, CO, 80014, US

(21) Appl. No.: 09/842,202

(22) Filed: Apr. 25, 2001

Related U.S. Application Data
(60) Provisional application No. 60/201,595, filed on May 3, 2000.

(51) Int. Cl. C04B 14/00; C04B 18/06

(52) U.S. Cl. 106/705; 106/710

(57) ABSTRACT

A method for the treatment of fly ash to remove carbon and other matter. The resulting treated fly ash has a fine particle size and low carbon content and is useful in cementitious compositions. Other useful by-products, such as commerial grade cenopheres, can also be recovered.

### CROSS-REFERENCE TO RELATED APPLICATIONS

This application claims priority from U.S. Provisional Application No. 60/201,595 filed on May 3, 2000, which is incorporated herein by reference in its entirety.

### BACKGROUND OF THE INVENTION

1. Field of the Invention

The present invention is directed to a novel method for the classification of pozzolanic materials, such as fly ash, that can improve the utility of the pozzolanic materials when used in cementitious compounds. The present invention is also directed to cementitious end products having exceptional impermeability, compressive strength, flexural strength, and durability as compared to conventional cement, which can be formed from cementitious compositions containing extremely low levels of calcium and uncharacteristically high levels of ultra-fine pozzolanic material, such as fly ash.

2. Description of Related Art

Cementitious compositions are utilized to form structural building products, such as concrete, as well as materials for sealing, such as grouts and mortars. The binder utilized in concrete is typically hydraulic cement, such as Portland cement, which is mainly comprised of calcined lime (calcium oxide). The cement is activated when mixed with water, binds with other materials in the composition including fillers such as sand and aggregates, and hardens forming the structural end product.

A pozzolan is a siliceous or siliceous and aluminous material possessing little or no cementitious property. In finely divided form, however, pozzolans will chemically react with calcium hydroxide in the presence of moisture to form cementitious compounds. Examples of pozzolans include silica fume, volcanic ash, calcined clays, amorphous silica, and fly ash. In some instances, pozzolans such as high-calcium fly ash also have cementitious properties related to the calcium and are regarded as both pozzolans and cementitious materials.

Fly ash is formed as a by-product of the combustion of coal in power plants. It is often utilized to replace a portion of the cement in cementitious compositions. In current practice, low carbon fly ash is typically added to cement without beneficiation because it is inexpensive relative to the cement and is known to improve the workability, flowability, pumpability, water requirement and heat of hydration in plastic concrete, and is known to improve the strength, impermeability, and durability of the hardened concrete. Characteristically, fly ash is added to cement in the range of 15 to 20 weight percent, although fly ash/cement mixtures containing up to 70 weight percent fly ash have also been successfully demonstrated. See, for example, “Concrete, Flyash, and the Environment—Proceedings,” a forum held Dec. 8, 1998, as reported in the Environmental Building News.

It is well known that adding very small particle size material to cement, for example silica fume or rice husks having a size of 10 μm or less improves the impermeability, durability, compressive strength and flexural strength of the cement. Silica fume and other small particles are routinely added when high performance cements (HPC) are required. While the benefits are well known, the level of substitution of ultra-fine material in even high performance cement is generally limited by its price, which is frequently five to ten times that of Portland cement.

It is also known that crushing or grinding fly ash or other particles may reduce their size by forcibly breaking their structure. However, the reduction of average particle size by these methods, for example from an average size of 45 μm to an average size of 4.5 μm, is too power intensive and costly for most commercial applications.

U.S. Pat. No. 3,876,005 by Fincher et al. discloses a cementing composition adapted for penetrating a subterranean formation. The composition includes 100 pbw pozzolanic material, 5 to 200 pbw hydraulic cement and 5 to 25 pbw lime. Water is added to a dry mixture of pozzolan, cement and lime to form the cement.

U.S. Pat. No. 4,121,945 by Hurst et al. discloses a wet method for the treatment of fly-ash to remove magnetic iron, remove carbon, remove cenospheres and decrease the size of the fly-ash.

U.S. Pat. No. 5,121,795 by Ewert et al. discloses a cement having a particle size of less than about 11 μm. It is disclosed that the cement can include fly ash as a component.

U.S. Pat. No. 5,346,012 by Heathman et al. discloses a fine particle size cement composition useful for cementing a subterranean zone penetrated by a well bore. The composition can include Class F fly ash having a size of less than about 10 μm.

U.S. Pat. No. 5,383,521 by Onan et al. discloses a cementing composition that includes Class C fly ash having a size of not greater than about 10 μm.

U.S. Pat. No. 5,584,895 by Seike et al. discloses a mixture including coal ash and a calcium compound wherein the mixture is formed into a molded article and then heated under high pressure to form building materials such as panels, blocks and bricks.

U.S. Pat. Nos. 5,714,002 and 5,714,003 both by Styron disclose a hydraulic cement composition that includes 85 to 99.7 weight percent Class C fly ash that includes a minimum of 21 weight percent calcium as CaO.

U.S. Pat. No. 5,887,724 by Weyand et al. discloses a method for reducing the carbon content of a bi-modal fly ash by subjecting the fly ash to vibrating screen separation to form a carbon rich component and a carbon depleted component that can be used in a concrete mixture.

U.S. Pat. No. 6,038,987 by Koshinski discloses a method for reducing the carbon content of fly ash by subjecting the ash to comminution and separation, such as in a fluidized jet mill.

Despite the foregoing, there remains a need for cementitious compositions that use exceptionally high levels of pozzolanic material such as fly ash and a reduced amount of calcium. There is also a need for an economic method for preparing very small particle size fly ash for use in cementitious compositions. It would be advantageous if such a method operated in a closed system that allowed substantially all of the fly ash to be utilized and avoided the expense and environmental risks associated with disposal of the fly ash.

### SUMMARY OF THE INVENTION

One embodiment of the present invention is directed to a method for the conditioning of pozzolanic materials. The conditioning method advantageously eliminates large particles to reduce the maximum particle size, reduce the average particle size and improve the consistency and reactivity of fly ash and other pozzolans. This method can include removing or breaking alumina silicate particles in the material and/or carbon and iron oxides contained in the fly ash. The process may also include the addition of a variety of chemicals to improve the cement and concrete characteristics when the beneficiated pozzolan is formed into a cementitious composition.

Another embodiment of the present invention is directed to the use of classified pozzolanic materials as a high-quality additive to Portland cement. The quantity of added pozzolanic material in relation to the total cementitious composition is determined by the structural requirements of the desired end product. The more demanding the specifications, the higher the percentage of pozzolanic additive of the present invention is required.

Another embodiment of the present invention is directed to cementitious compositions that include a pozzolanic material such as fly ash as a primary component and a reduced amount of calcium to form a cement end product. The pozzolanic material has a very small average particle size, such as not greater than about 15 μm, and the composition includes at least about 80 weight percent of the pozzolanic material. The cementitious composition also has a very low level of calcium, such as not greater than about 20 weight percent calcium oxide, that is present in such a way that advantageously provides improved cement properties.

A small particle size is an important feature of the present invention because it provides superior packing density of the cement paste surrounding the aggregate, increases reactivity, provides a high surface area and a reduction in pore size when pores are not filled completely. Flow rate or quantity through these pore spaces is proportional to the square of the pore diameter. Smaller dimensions therefore improve the entire internal pore structure and impermeability of the concrete and diminish or eliminate microcracking.

A small particle size in the transition zones of the concrete also strengthens the concrete by providing increased surface area that increases pozzolan reactivity and the extent of hydration and improves interfacial binding action. Chemicals, such as acetates, chlorides or citric acid, when added by solubilizing in water, can facilitate more complete distribution of calcium ions and subsequent creation of calcium silicate hydrates that enhance the integrity of concretes. Transition zones are filled much more completely with small, non-crystalline particles of calcium silicate hydrate rather than water or weak and loosely associated calcium hydrate crystals typical of concretes bound by conventionally sized Portland cement.

Effective distribution and availability of calcium dramatically reduces the calcium oxide requirement to 20 weight percent or less of the weight of the dry constituents. Using minimal amounts of calcium discourages the formation of calcium hydroxide, the free lime by-product of ordinary cement hydration. Calcium hydroxide in concrete creates weak transition zones and is subject to the delibitating effects of alkali-silica reactions (ASR). In ASR, calcium hydroxide, water, reactive silica (sometimes present in aggregates) and soluble metal alkali ions form an expansive gel that can crack the cement matrix. According to a preferred embodiment of the present invention, substantially all available calcium is fully reacted to produce strong calcium silicate hydrate, and excess calcium as hydroxide is therefore unavailable to produce weak calcium hydrate. Additionally, since little or no calcium hydrate is present to migrate to the surface, efflorescence, a condition that mars concrete aesthetics with light-colored stains of calcium carbonate, is reduced or eliminated.

In order to attain a consistent and superior fly ash feedstock for use as a cement end product or a cement additive, beneficiation to reduce particle size and reduce contaminants is an important aspect of the present invention using various forms of pozzolanic and/or cementitious materials.

Solid, non-crystalline (amorphous) spherical particles in fly ash typically range in size from about 1 μm to 20 μm, with an average size of about 5 μm. See, for example, FIG. 3, which illustrates a photomicrograph of the solid amorphous spherical particles that are commonly found in such fly ash compositions. Table 1 illustrates various types of fly ash particle sizes and structures.

TABLE 1
Types of Fly Ash by Size and Structure

| | | Characteristic |
|---|---|---|
| | | Size Range |
| Shape | Crystallinity and Texture | (μm) |
| Spherical and rounded | a) Glassy, clear, solid | |
| | b) Glassy, containing small | 0-20 |
| | bubbles | |
| | c) Glassy, with crystal traces | |
| | d) Predominantly crystalline, | 10-50 |
| | solid | |
| Spherical and rounded | Glassy, solid | 5-30 |
| Rounded | Glassy, spongy | 10-200 |
| Irregular | Partly crystalline, solid | 10-100 |
| Irregular | Partly crystalline, solid | 50-500 |
| Irregular | Solid or porous | 20-200 |
| Angular | Crystalline, solid | 10-100 |
| Angular | Crystalline, solid | 5-50 |

A study of unbeneficiated U.S. fly ashes found that over 40 weight percent of the particles were under 10 μm in size, about 45 weight percent were between 10 μm and 45 μm and less than 15 weight percent were above 45 μm. Irregular masses of large size usually consist of either incompletely burned carbon, agglomeration of molten ash spheres or iron oxide particles. Cenospheres, although spherical, are sometimes 200 μm or larger and are often present in low-calcium fly ash. Class C (high-calcium) fly ash particles typically average less than 20 μm in diameter with 10 to 15 weight percent of the particles being larger than about 45 μm. Low-calcium fly ash particles typically average about 20 μm in diameter with 15 to 30 weight percent of the particles larger than 45 μm.

According to one embodiment of the present invention, the beneficiation of the fly ash provides for removal of carbon if the carbon in the fly ash exceeds about 6 weight percent. Carbon content, or loss on ignition (LOI), refers to the large, unburned carbon particles remaining in the fly ash. Carbon has a negative effect in cement, particularly when fly ash is used as an additive to Portland cement. In particular, carbon tends to absorb the air-entraining agent often added to Portland cement mixtures making it unavailable for generating an air void system in air-entrained concrete. Carbon also tends to discolor concrete. The American Society for Testing and Materials (ASTM) C-618 standard limits LOI to 6 weight percent and many users restrict LOI to one weight percent. The most common reason for disposal of fly ash in the U.S. is due to high LOI.

Carbon agglomerates on fly ash particles also increase the average particle size of fly ash. The method of the present invention can advantageously remove carbon from fly ash, when necessary, that will allow newly generated as well as previously landfilled fly ash to be reclaimed for productive use in cementitious compositions.

Cenospheres, glassy, gas-filled spherical particles often present in fly ash, can also be eliminated from the fly ash by the process of the present invention. Cenospheres are substantially larger in size with a markedly lower specific gravity than the solid amorphous spherical particles comprising the bulk of the fly ash. During beneficiation, most of the cenospheres are removed through classification for the purpose of lowering overall particle size and because they are a valuable, saleable by-product. Cenospheres remaining in the ash can be crushed or ground to much smaller sizes, if desired. Iron oxides, another group of large particles, can also be selectively removed from the fly ash in accordance with the present invention.

### DESCRIPTION OF THE DRAWINGS

FIG. 1 illustrates a photomicrograph of a Portland cement composition in accordance with the prior art.

FIG. 2 illustrates a photomicrograph of a concrete composition in accordance with the prior art.

FIG. 3 illustrates a photomicrograph of spherical fly ash particles.

FIG. 4 illustrates a flowsheet of a process according to an embodiment of the present invention including the treatment of high-carbon fly ash.

FIG. 5 illustrates a flowsheet of a process according to another embodiment of the present invention including the treatment of low-carbon fly ash.

### DESCRIPTION OF THE INVENTION

One embodiment of the present invention advantageously exploits the combined effects of very small pozzolan particle size and well-distributed, readily available calcium to provide increased strength in the transition zones of concrete. Transition zones are areas of interfacial bonding between aggregates and cements that greatly influence the impermeability, durability, flexural strength and compressive strength of concrete. Severe structural problems widely evident in concrete based on Portland cement can often be traced to problems attributable to weak transition zones.

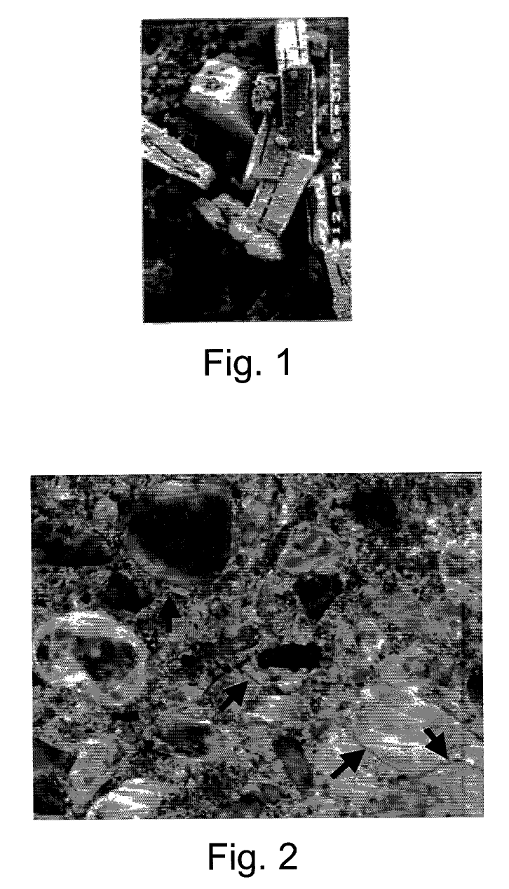

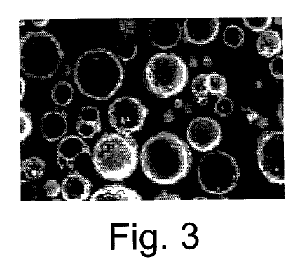

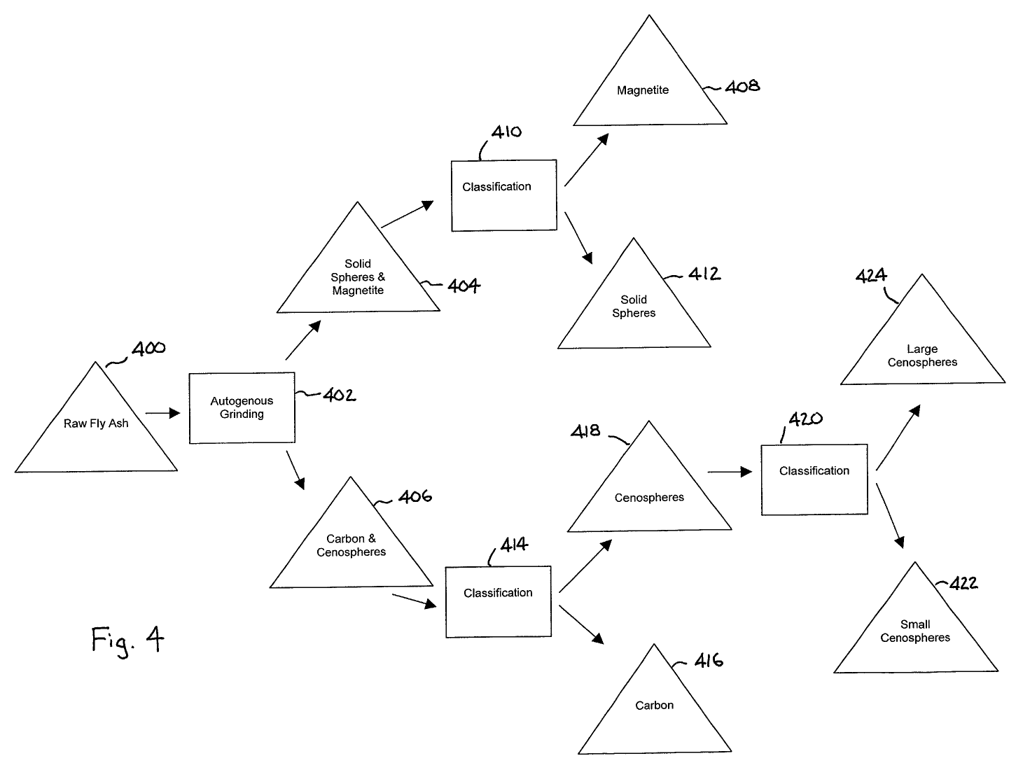

Large calcium hydroxide crystals in typical Portland cement often lead to a lack of structural integrity in transition zones due to the crystal's poor contact with the aggregate used in concrete. See FIG. 1, for example. The resultant weak bonds are further compromised by the formation of large voids, or pores, around the aggregate that tend to fill with water that is not consumed in the process of hydration. Given these conditions, Portland cement compositions can easily crack and separate, a condition known as microcracking, when stressed by shrinkage, expansion, early loading, or other factors. Interconnections of microcracks often lace the concrete, destroying its water tightness and forming channels of flow that allow outside invasion of aggressive chemicals resulting in dramatic reductions in strength and durability. See, for example, FIG. 2.

The fact that typical Portland cement often deteriorates years or decades earlier than expected, requiring extensive repair or total replacement, creates more than the obvious economic penalty. Approximately one ton of carbon dioxide (CO₂), the principal greenhouse gas, is emitted for every ton of cement produced. In 1999, 1.3 billion tons of cement were produced and 1.3 billion tons of CO₂ were released into the atmosphere as a result. Approximately eight percent of CO₂ emissions produced by man are related to the heating and calcining of limestone to fulfill calcium requirements in the production of cement. On the other hand, every ton of fly ash or other pozzolanic material that can be used in place of conventional cement reduces CO₂ emissions by one ton.

The present invention enables the use of high levels of fly ash for cementitious compositions and can advantageously reduce the calcium requirement from that used in Portland cement by 75 percent or more while maintaining excellent and unique cementitious properties.

Another positive environmental impact inherent in the present invention is the utilization of the coal combustion by-product, fly ash, which might be or has been otherwise disposed in landfills and ponds. Productive use of this material eliminates the potential risk of groundwater contamination by hazardous leachates from fly ash waste impoundments and allows higher use of land resources. According to the American Coal Ash Association, over 57 million metric tons of fly ash were produced in the U.S. alone in 1998 and approximately 36 million metric tons were ponded or landfilled.

The use of fly ash and other pozzolanic materials in the production of cement not only improves air, water, and land quality directly, but because compositions based on the invention have superior impermeability, many of these cements are suitable for the stabilization of heavy metals and other wastes.

One embodiment of the present invention is directed to the beneficiation of pozzolanic material, such as fly ash, to provide a useful pozzolanic product and to make use of the other components of the fly ash. The beneficiated pozzolanic material is useful as the pozzolanic material in the production of a cementitious composition end product. The beneficiated pozzolanic material is also useful for other purposes including: (1) a consistent, high quality fly ash additive to cement; and (2) a substitute for high-cost strength enhancers, such as silica fume and kaolin clay-based products in cement.

Fly ash is a by-product from the combustion of coal and typically includes silica, alumina and other oxides. Among the other oxides contained in fly ash are iron oxides, magnesium oxides and the like. Depending upon the composition of the coal, the fly ash can be classified as Class C fly ash or Class F fly ash. Class C fly ash has a higher a degree of calcium (in the form of CaO) than Class F fly ash and the CaO content in Class C fly ash is usually at least 20 weight percent. A typical Class F fly ash composition is illustrated in Table 2.

TABLE 2
Typical Class F Fly Ash Composition

| COMPONENT | WEIGHT PERCENT |
|---|---|
| SiO₂ | 35-55 |
| Al₂O₃ | 15-35 |
| FeO/Fe₂O₃ | 3-25 |
| CaO | 3-8 |
| MgO | 0.5-3 |
| TiO₂ | 1-3 |
| Na₂O | 0.7-1 |
| K₂O | 1-6 |
| SO₃ | 1-3 |
| C | 0.5-10 |
| H₂O | 0.5-0.7 |

The beneficiation of fly ash and other pozzolanic materials in accordance with the present invention can include the step of grinding the pozzolanic material to reduce carbon content and particle size. However, such a grinding step, if used, is designed to separate the constituent materials rather than break the particles and therefore requires less energy and cost than high intensity grinding. If ultra-small sizes and an irregularly shaped pozzolanic material are desired, the method of the present invention may employ crushing and grinding but only to a fraction of the original fly ash or to the whole quantity once it has already been substantially reduced in size by less power intensive processes. In both cases, substantial reduction by separation radically reduces energy requirements and costs associated with grinding.

The beneficiation process according to the present invention can therefore include the treatment of fly ash containing greater than about 2 weight percent carbon. In general such a pozzolanic material will include 75 to 95 weight percent alumina and silica, 2 to 20 weight percent carbon and 1 to 5 weight percent iron oxide (e.g., magnetite). The maximum particle size of fly ash material is typically not greater than about 500 μm and 30 to 50 weight percent of the particles are typically not greater than about 10 μm in size. The size and precise mineral makeup of unbeneficiated fly ash is dependent upon numerous factors including the host coal composition and the operating and design conditions of the boiler in which it was created.

In general, the alumina and silica, often in the form of aluminosilicate compounds including calcium, are in a molten state in the combustion zone of the power plant boiler and are precipitated as amorphous spherical particles. Some spherical particles are solid, amorphous and very small, such as 10 μm to 15 μm or less. Other spheres, referred to as cenospheres, contain gas and are lighter, more friable and frequently many times larger than the solid amorphous spherical particles. Carbon that is present in the fly ash tends to be contained as large irregular particles or tends to agglomerate on the surface of both solid amorphous particles and cenospheres, substantially increasing the average particle size of the fly ash. Iron oxides contained in the fly ash also tend to be larger than the solid amorphous spherical particles and therefore tend to increase the average particle size of the fly ash.

Fly ash intended for cement is unacceptable by the standards of ASTM C-618 if the carbon content is above 6 weight percent. The cement industry generally prefers that the carbon be kept below about 3 weight percent and it is even more preferred if no more than about 1 weight percent carbon is present. Removal of carbon has been shown to reduce overall fly ash particle size, but the reduction in size has been an unintended result produced by removing carbon to acceptable cement industry levels. The amount of size reduction by removal of carbon is wholly dependent upon the amount of carbon originally contained and the percentage of the carbon that has agglomerated to the oxide compounds in the fly ash.

Selectively removing or crushing cenospheres can achieve further size reduction of the composition. Cenospheres having a specific gravity of not greater than about 0.5 have a high market value for use as fillers in plastics and the like. Separating commercial quality cenospheres has the dual advantage of producing a salable by-product and reducing the average particle size of the fly ash. As with carbon, the percentage size reduction possible by removing or crushing cenospheres is dependent upon variables including the percentage of the cenospheres contained in the fly ash, their size and their relative weight. Because cenospheres contain a gas and are very light, the volume percentage of cenospheres will always be larger than their weight percentage when compared with heavier particles.

Iron oxide contained in the fly ash will also tend to be larger in size than the solid amorphous alumina-silicate spherical particles. Therefore, the removal of the iron oxides will also reduce the average fly ash particle size. The majority of iron oxides contained in fly ash are in the form of magnetite, which has a substantial commodity value and can be sold.

If the carbon, cenospheres and iron oxides are separated and removed, the average particle size of the fly ash will typically have been reduced to below about 5 μm with a maximum particle size of about 15 μm or less, such as 10 μm or less. The remaining particles will consist almost entirely of solid amorphous alumina-silicate spherical particles.

Because some elements of cement performance can be further improved with even smaller size particles, it may be desirable to further chemically reduce the fly ash particle size during hydration. For example, the addition of very small amounts of acetates, chlorides, citric salts or citric acid, such as about 0.1 to 3 weight percent, preferably about 0.5 weight percent, will solublize available calcium oxide contained in the fly ash, therefore increasing the surface area of the remaining fly ash. Depending upon the relative strength, effect and cost of chemicals used, chemical reduction may be preferred at any stage of the flowsheet where further reductions in size can be effected in this way.

While the average particle size of beneficiated fly ash may be as large as 15 μm it may, if all or most process steps described herein are used, be reduced such that the average particle size is not greater than about 5 μm, or even such that the average particle size is not greater than about 1 μm.

When a cement composition is formed in accordance with the present invention, the cost of its manufacture, including a calcium oxide source, is expected to be far less than Portland cement having comparable qualities. The value of such a product as a cement additive, as compared to products such as silica fume that produce similar results, may be an order of magnitude greater than its cost of production. The beneficiated fly ash also has numerous environmental advantages including the elimination of polluting solid waste material and a reduction of CO₂ emissions by replacement of the conventional high calcium cement.

The preferred process steps to beneficiate fly ash to produce a high performance cement additive or principal feedstock for cement compositions according to the present invention are as follows.

The carbon in the fly ash is removed such that the carbon content is not greater than about 6 weight percent of the fly ash, more preferably not greater than about 2 weight percent and even more preferably not greater than about 1 weight percent. The removal of carbon can be done in several ways. For example, efficient boiler operation, fluidized bed combustion, electrostatic separation, chemical treatment, or autogenous grinding can remove the carbon. A preferred method according to the present invention is low impact autogenous grinding of a dry feedstock followed by classification of the particles to remove carbon if its level is excessive. A method for the removal of carbon from fly ash is illustrated in U.S. Pat. No. 6,038,987 by Koshinski, which is incorporated herein by reference in its entirety.

Iron oxides (e.g., magnetite) can be removed such that the iron oxide content is not greater than about 1 weight percent, more preferably not greater than about 0.5 weight percent. Dry or wet processing using magnetic separators employing permanent or electromagnets can be used to remove iron oxides. Another method is dry classification using a jet mill. Because iron oxide particles have a specific gravity (SG) of greater than about 5 and are larger in size than most other particles, they are relatively easy to separate in jet mills.

Cenospheres can also be removed from the fly ash. A simple sink float circuit can remove cenospheres since they have a specific gravity of less than about 1. Because cenospheres are both lighter and larger than most material contained they can also be easily separated dry by classification in a jet mill, and the use of a jet mill is often preferred.

Acetates, chlorides, citric salts, citric acid or other chemicals can be added to the beneficiated ash to further enhance contact with available calcium through solublization of calcium during hydration of the cement composition.

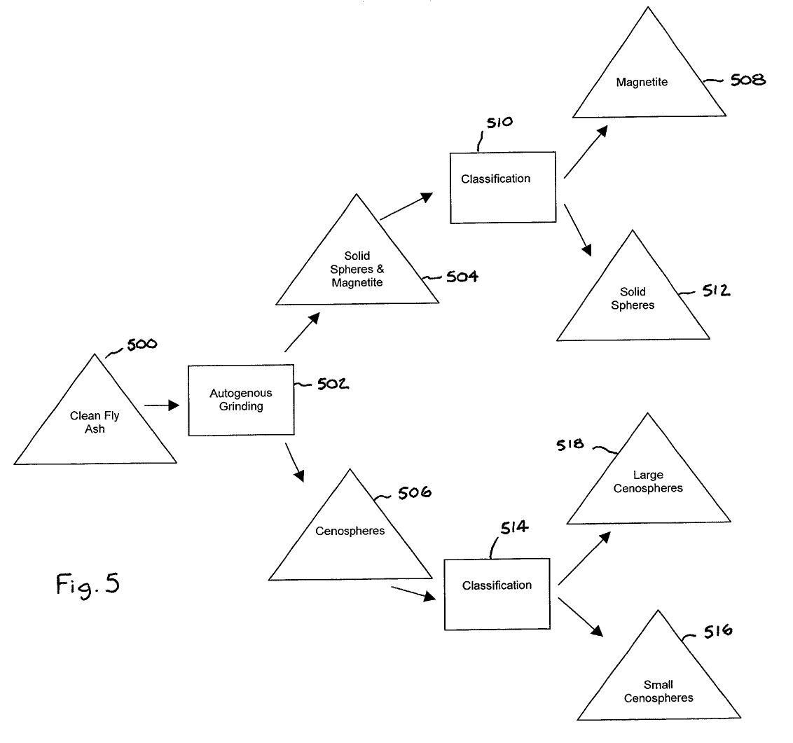

Preferred embodiments of the fly ash beneficiation method according to the present invention will now be described with reference to FIGS. 4-5.

Referring to FIG. 4, fly ash 400 is conveyed pneumatically to a series of process steps for autogenous grinding and classification. The fly ash can be raw fly ash or can be a fly ash product resulting from one or more initial separation steps. For example, U.S. Pat. No. 6,038,987 discloses a method for the separation of raw fly ash into a low-carbon product (e.g., below about 6 weight percent carbon) and a high-carbon product that includes a fine fly ash fraction having an average particle size of net greater than about 7 μm. This high-carbon product is typically disposed since it is not useful for an additive in cementitious compositions. The method of the present invention advantageously permits the separation of this carbon and the use of the fine fly ash fraction.

The operation of jet mills is described in detail in U.S. Pat. No. 6,038,987. Generally, air jet nozzles are configured such that the velocity and momentum of the air leaving the nozzles creates a flow pattern that draws the particles into the center of each jet where they are accelerated to the impact velocity required to achieve some degree particle comminution and/or beneficiation when the particles impact each other. The degree of particle interaction can be controlled, for example, by controlling the velocity of the air streams and the number of nozzles. The jet mills are controlled in order to provide different processing parameters for each step.

First, low impact autogenous grinding 402 is used to liberate carbon particles from the amorphous spherical fly ash particles. The heavier fraction 404, above a specific gravity of about 1.6, is separated from the lighter fraction 406 having a specific gravity lower than about 1.6. Iron oxide (if present) and solid amorphous spherical particles will report to the heavier fraction 404 while cenospheres and carbon will constitute the lighter fraction 406.

The heavier fraction 404 will then be further separated 410 at a specific gravity cut-off of about 3 wherein iron oxides 408 (specific gravity about 5 or higher) will be separated from amorphous alumina and silicate spherical particles 412 that have a specific gravity of below about 2.5.

Meanwhile, the light fraction 406 having a specific gravity of less than about 1.6 will be separated 414 at a specific gravity of about 1.2. Any carbon 416 (specific gravity of greater than about 1.28) will report to the heavier fraction and cenospheres 418 (specific gravity of 0.2 to 1.2) will report to the lighter fraction where the cenospheres can be further separated 420 to provide a lighter fraction 422 having a specific gravity of about 0.5 or less that is commercially useful as a filler material in plastics or the like. Other cenospheres 424, which are very friable, can be crushed by intense autogenous grinding to break the particles to a maximum size of about 10 μm or less and remixed with the solid spherical particles 412. The mixture can then be used as a component of a cementitious composition. Any combination of these process steps can be used to produce a product having a maximum particle size of about 15 μm or less, as may be desired.

If additives such as acetates, chlorides, citric acid or citric salts are needed and introduced as a powder, another autogenous grinding step is conducted at low intensity if only mixing is needed. Intense autogenous grinding is conducted to break spheres, increase surface area, and mix chemical additives if a higher surface area and smaller particles are desired. If cement is being made using beneficiated fly ash and calcium oxide, the chemical additives and calcium oxide can be mixed and commuted simultaneously.

FIG. 5 illustrates a similar process for the treatment of a low-carbon fly ash 500. First, low impact autogenous grinding 502 is used to separate the solid spherical particles and magnetite from the cenosphere. The heavier fraction 504, above a specific gravity of about 1.6, is separated from the lighter fraction 506 having a specific gravity lower than about 1.6. Iron oxide (if present) and solid amorphous spherical particles will report to the heavier fraction 504 while cenospheres will constitute the lighter fraction 506.

The heavier fraction 504 will then be further separated 510 at a specific gravity cut-off of about 3 wherein iron oxides 508 (specific gravity about 5 or higher) will be separated from amorphous alumina and silicate spherical particles 512 that have a specific gravity of below about 2.5.

Meanwhile, the light fraction 506 having a specific gravity of less than about 1.6 will be separated 514 at a specific gravity of about 0.5. The cenospheres are thereby separated to provide a lighter fraction 516 having a specific gravity of about 0.5 or less that is commercially useful as a filler material in plastics or the like. Other cenospheres 518, which are very friable, can be crushed by intense autogenous grinding to break the particles to a maximum size of about 10 μm or less and remixed with the solid spherical particles 512. The mixture can then be used as a component of a cementitious composition.

Another embodiment of the present invention is directed to a cementitious composition end product that can be used as the binder or cement in structural products, grouting compositions, mortars or the like.

The primary component of the cementitious composition is a pozzolanic material. A preferred pozzolanic material is fly ash, such as Class C or Class F fly ash.

According to the present invention, it is preferred that the pozzolanic material has a small average particle size to provide a cementitious composition having adequate strength properties. Preferably, the average particle size is not greater than about 15 μm, more preferably is not greater than about 10 μm and even more preferably is not greater than about 7 μm. In one embodiment the average particle size is not greater than about 4 μm, such as not greater than about 1 μm. In one preferred embodiment, substantially 100 percent of the pozzolanic material has a particle size of not greater than about 15 μm, more preferably not greater than about 10 μm.

According to the present invention, the cementitious composition includes an extraordinarily high percentage of pozzolanic material, higher than has been utilized heretofore. Thus, the cementitious composition advantageously includes at least about 80 weight percent of pozzolanic material having very small particle size. More preferably, the composition includes at least about 85 weight percent, even more preferably at least about 90 weight percent and most preferably at least about 95 weight percent of the pozzolanic material. In one embodiment, the cementitious composition includes at least about 98 weight percent of the pozzolanic material.

In order to form the cementitious compositions of the present invention, the compositions include calcium. The calcium source can be selected from various calcium compounds, such as calcium hydroxide (Ca(OH)₂) or calcium oxide (CaO). The calcium source can be derived from Portland cement, supplied directly as lime, can be contained in the pozzolanic material feed (e.g., Class C fly ash), or can be a combination of the foregoing. In any event, it is preferred that the average particle size of the calcium source is small compared to the pozzolanic material so that calcium can effectively coat the surface of the pozzolanic material. Therefore, the particle size of the calcium compound (e.g., CaO) should be reduced if necessary to substantially less than the particle size of the pozzolanic material by mechanical or chemical means.

Sufficient calcium ions are necessary to form the cementitious composition of the present invention, and therefore the cementitious composition preferably includes at least about 2 weight percent calcium. However, it has been found according to the present invention that the amount of calcium can optionally be reduced as compared to compositions described in prior art while substantially improving important cement properties. Preferably, the composition includes not greater than about 20 weight percent calcium. It is also possible to use lower levels of calcium oxide, such as not greater than about 15 weight percent, even not greater than about 10 weight percent calcium, and even not greater than about 5 weight percent calcium oxide. Preferably, the calcium ions will be present in the minimum amount necessary to react with pozzolanic material and produce maximum calcium silica hydrate while avoiding formation of substantial amounts of unreacted calcium hydrate. If the pozzolanic material contains a high level of calcium oxide (e.g., Class C fly ash), the pozzolanic material can be blended with other low-calcium pozzolans to reduce the total calcium content in accordance with the foregoing. In any case, the total calcium required is less than compositions referenced in the prior art.

In general, the size of solid precipitated spherical particles of amorphous alumina silicate is less than about 15 μm in size, typically having an average particle size of less than about 5 μm. Carbon, as distinct particles or agglomerated to other particles, is larger in size and when removed reduces average particle size. The same is true of cenospheres and iron oxides. If these components are all removed, the average particle size of the fly ash becomes the size of the remaining amorphous silica spherical particles, e.g., less than about 5 μm. According to the present invention, this benefaction can be accomplished with minimum grinding and expense.

It is also preferred that the composition includes not greater than about 2 weight percent, more preferably not greater than about 1 weight percent, and even more preferably not greater than about 0.5 weight percent carbon. Some carbon may enter the composition through the pozzolanic material, however, it is preferred that the pozzolanic material be treated to remove carbon if the material contains more than about 2 weight percent carbon.

According to one embodiment, it is also preferred to remove iron oxide compounds from the pozzolanic material due to their relatively large size. Thus, it is preferred that the composition includes not greater than about 2 weight percent iron oxides, more preferably not greater than about 1 weight percent iron oxides and even more preferably not greater than about 0.5 weight percent iron oxides, such as iron in the form of magnetite (Fe₃O₄). However, if brackish water (e.g., sea water) is used to form the cement, it may be preferred not to remove the compounds containing iron oxides.

Pozzolanic material such as fly ash can include hollow glassy cenospheres, filled with gas. Such cenospheres tend to be much larger than solid fly ash spheres, more fragile, and can reduce the strength of articles formed from the composition. Therefore it is preferred that the pozzolanic material includes not greater than about 2 weight percent cenospheres, more preferably not greater than about 1 weight percent cenospheres and even more preferably includes not greater than about 0.5 weight percent cenospheres.

Other additives as may be needed to adjust setting times, workability, and other conditions can be added to the cementitious composition as needed. One important aspect for attaining the characteristics of a high quality cement with minimum calcium content is the efficient distribution of the available calcium on the relatively large surface area of the micronized pozzolanic particles. Chemical additives, for example acetates, chlorides, citric salts or citric acid, can advantageously make calcium oxide particles more soluble when water is added and therefore can facilitate the coating of the pozzolanic particles with calcium.

The above-described cementitious composition can be formed into a flowable cement by adding water. The composition of the present invention advantageously permits a reduced amount of water to be used to obtain a quality cement product. According to one embodiment, the amount of water added is preferably not greater than about 30 weight percent relative to the weight of the dry powder blend described above.

The distribution of calcium, the flowability of the concrete mixtures and the effect of chemicals, can be enhanced by treatment of the water, such as by using an electromagnetic water conditioner. Conditioned water has the effect of reducing surface tension, enables the water to wet the particles more effectively than unconditioned water and maintains calcium and chemical particles in a colloidal state to enhance effective distribution.

The cementitious composition according to the present invention advantageously has exceptionally low permeability that enhances its flexible strength, compressive strength, and durability. The cement will also have reduced shrinkage due to minimal water use and low thermal cracking due to a reduced heat of hydration resulting from minimal calcium content.

While various embodiments of the present invention have been described in detail, it is apparent that modifications and adaptations of those embodiments will occur to those skilled in the art. However, it is to be expressly understood that such modifications and adaptations are within the spirit and scope of the present invention.

What is claimed is:

1. A composition, comprising:
a) at least about 80 weight percent pozzolanic material having an average particle size of not greater than about 15 μm;
b) up to about 20 weight percent calcium oxide; and
c) not greater than about 2 weight percent carbon.

2. A composition as recited in claim 1, wherein said composition comprises at least about 85 weight percent of said pozzolanic material.

3. A composition as recited in claim 1, wherein said composition comprises at least about 90 weight percent of said pozzolanic material.

4. A composition as recited in claim 1, wherein said composition comprises at least about 95 weight percent of said pozzolanic material.

5. A composition as recited in claim 1, wherein said pozzolanic material comprises fly ash.

6. A composition as recited in claim 1, wherein said pozzolanic material has an average particle size of not greater than about 10 μm.

7. A composition as recited in claim 1, wherein said pozzolanic material has an average particle size of not greater than about 4 μm.

8. A composition as recited in claim 1, wherein said composition comprises not greater than about 10 weight percent calcium oxide.

9. A composition as recited in claim 1, wherein said composition comprises not greater than about 5 weight percent calcium oxide.

10. A composition as recited in claim 1, wherein said calcium oxide is present as a coating on said pozzolanic material.

11. A composition as recited in claim 1, wherein said composition comprises not greater than about 1 weight percent carbon.

12. A composition as recited in claim 1, wherein said composition comprises not greater than about 0.5 weight percent carbon.

13. A composition as recited in claim 1, wherein said composition comprises not greater than about 1 weight percent iron oxides.

14. A composition as recited in claim 1, wherein said pozzolanic material comprises not greater than about 2 weight percent cenospheres.

15. A composition as recited in claim 1, wherein said pozzolanic material comprises not greater than about 1 weight percent cenospheres.

16. A composition as recited in claim 1, wherein said composition further comprises an additive selected from the group consisting of acetates, chlorides, citric acid and a citric salt.

17. A flowable cementitious composition, comprising:
a) a dry powder blend comprising at least about 80 weight percent pozzolanic material and not greater than about 20 weight percent calcium oxide wherein said pozzolanic material has an average particle size of not greater than about 15 μm; and
b) not greater than about 30 weight percent water calculated based on said dry powder blend.

18. A cementitious composition as recited in claim 17, wherein said dry powder blend comprises at least about 85 weight percent of said pozzolanic material.

19. A cementitious composition as recited in claim 17, wherein said dry powder blend comprises at least about 90 weight percent of said pozzolanic material.

20. A cementitious composition as recited in claim 17, wherein said dry powder blend comprises at least about 95 weight percent of said pozzolanic material.

21. A cementitious composition as recited in claim 17, wherein said pozzolanic material comprises fly ash.

22. A cementitious composition as recited in claim 17, wherein said cementitious composition comprises not greater than about 10 weight percent calcium oxide.

23. A cementitious composition as recited in claim 17, wherein said cementitious composition comprises not greater than about 5 weight percent calcium oxide.

24. A cementitious composition as recited in claim 17, wherein said pozzolanic material has an average particle size of not greater than about 10 μm.

25. A cementitious composition as recited in claim 17, wherein said calcium is present as a coating on said pozzolanic material.

26. A cementitious composition as recited in claim 17, wherein said cementitious composition comprises not greater than about 1 weight percent carbon.

27. A cementitious composition as recited in claim 17, wherein said cementitious composition comprises not greater than about 1 weight percent iron oxides.

28. A cementitious composition as recited in claim 17, wherein said pozzolanic material comprises not greater than about 2 weight percent cenospheres.

29. A cementitious composition as recited in claim 17, wherein said pozzolanic material comprises not greater than about 1 weight percent cenospheres.

30. A cementitious composition as recited in claim 17, wherein said cementitious composition further comprises an additive selected from the group consisting of acetates, chlorides, citric acid and a citric salt.

31. A cementitious composition as recited in claim 17, wherein said water is brackish water.

32. A method for making a cementitious composition, comprising the steps of:
a) providing a pozzolanic material;
b) treating said pozzolanic material to reduce the average particle size of said pozzolanic material to not greater than about 15 μm; and
c) removing carbon from said pozzolanic material so that the carbon content is not greater than about 1 weight percent; and
d) adjusting the composition of said pozzolanic material such that calcium oxide is in an amount of not greater than about 20 weight percent.

33. A method as recited in claim 32, further comprising the step of removing iron compounds from said pozzolanic material.

34. A method as recited in claim 32, wherein said pozzolanic material comprises fly ash.

35. A method as recited in claim 32, wherein said treating step comprises removing cenospheres from said pozzolanic material.

36. A method as recited in claim 32, wherein said treating step comprises removing carbon from said pozzolanic material.

37. A method as recited in claim 32, wherein said treating step comprises eliminating cenospheres from said pozzolanic material.

38. A method for treating fly ash, comprising the steps of:
a) separating said fly ash into a first portion and a second portion, wherein said first portion has a higher specific gravity than said second portion;
b) separating said first portion into a third portion and a fourth portion wherein said third portion has a higher specific gravity than said fourth portion; and
c) separating said second portion into a fifth portion and a sixth portion wherein said fifth portion has a higher specific gravity than said sixth portion.

39. A method for treating fly ash as recited in claim 38, wherein said first portion comprises solid amorphous spherical particles and magnetite.

40. A method for treating fly ash as recited in claim 38, wherein said third portion comprises magnetite.

41. A method as recited in claim 38, wherein said fourth portion comprises solid amorphous spherical particles.

42. A method as recited in claim 38, wherein said second portion comprises carbon and cenospheres.

43. A method as recited in claim 38, wherein said fifth portion comprises cenospheres.

44. A method as recited in claim 38, wherein said sixth portion comprises carbon.

45. A method as recited in claim 38, wherein said fifth portion is separated into a seventh portion and an eighth portion wherein said seventh portion comprises cenospheres having a specific gravity below a predetermined level.

46. A method as recited in claim 38, wherein said step of separating said fly ash comprises low impact autogenous grinding.
